(19) United States
(12) Patent Application Publication
(10) Pub. No.: US 2025/0218703 A1
(43) Pub. Date: Jul. 3, 2025

(54) CHARACTER CONCEALABLE KEYCAP MODULE

(71) Applicant: SUNREX TECHNOLOGY CORP., Taichung City (TW)

(72) Inventors: Yin CHU, Chongqing City (CN); Bao-Song Ma, Chongqing City (CN); Shih-Pin Lin, Taichung City (TW)

(73) Assignee: SUNREX TECHNOLOGY CORP., Taichung City (TW)

(21) Appl. No.: 18/816,455

(22) Filed: Aug. 27, 2024

Related U.S. Application Data
(60) Provisional application No. 63/615,820, filed on Dec. 29, 2023.

(51) Int. Cl. H01H 13/04; H01H 13/02

(52) U.S. Cl. CPC H01H 13/04; H01H 13/023; H01H 2223/038

(57) ABSTRACT

A character concealable keycap module includes a first cap structure, a light covering layer, and a second cap structure. The first cap structure is made of a transparent material and located above a backlight module. The light covering layer covers the first cap structure and has a patterned hollow area that defines a transparent character area on the first cap structure. The second cap structure has a transmittance lower than that of the first cap structure, and is disposed above the first cap structure to cover the light covering layer. When the backlight module is not switched on, the transparent character area is not visible through the second cap structure. When the backlight module is switched on, light emitted from the backlight module passes through the second cap structure, and the transparent character area is visible through the second cap structure.

### CROSS-REFERENCE TO RELATED APPLICATION

This application claims the benefit of U.S. Provisional Patent Application No. 63/615,820, filed on Dec. 29, 2023, and incorporated by reference herein in its entirety.

### FIELD

The disclosure relates to a keycap, and more particularly to a keycap module with concealable character.

### BACKGROUND

Conventional keycaps are adapted to be mounted on a backlit keyboard of a laptop computer. The backlit keyboard includes a backlight module. Each of the conventional keycaps includes a cap structure, and a character that is spray painted onto the cap structure. When a user opens the laptop computer and exposes the conventional keycaps on the backlit keyboard, the backlight module of the backlit keyboard emits light to illuminate the characters on the cap structure so that the user may easily identify the characters on each keycap.

However, the characters that are spray painted onto the cap structures of the keycaps may be rubbed away after prolonged use.

### SUMMARY

Therefore, an object of the disclosure is to provide a character concealable keycap module that can alleviate at least one of the drawbacks of the prior art.

According to the disclosure, the character concealable keycap module is adapted to be mounted on a support module of a key that is in turn mounted on a backlight module of a backlit keyboard. The character concealable keycap module includes a first cap structure, a light covering layer, and a second cap structure. The first cap structure is made of a transparent material and located above the backlight module. The light covering layer covers the first cap structure and has a patterned hollow area that defines a transparent character area on the first cap structure. The second cap structure has a transmittance lower than that of the first cap structure, and is disposed above the first cap structure to cover the light covering layer. When the backlight module is not switched on, the transparent character area is not visible through the second cap structure. When the backlight module is switched on, light emitted from the backlight module passes through the second cap structure, and the transparent character area is visible through the second cap structure.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a first embodiment of a character concealable keycap module according to the present disclosure.

FIG. 2 is an exploded perspective view illustrating the first embodiment of the disclosure.

FIG. 3 is a perspective view of the first embodiment when it is assembled.

FIG. 4 is a cross-sectional view of the first embodiment.

FIG. 5 is schematic cross-sectional view of the first embodiment installed on a support module, and the support module is stalled to a backlight module of a backlit keyboard.

FIG. 6 is a schematic perspective view illustrating the first embodiment when the backlight module is switched on and light emitted form the backlight module passes through a second cap structure, and a transparent character area is visible through the second cap structure.

FIG. 7 is an exploded perspective view illustrating a second embodiment of the character concealable keycap module according to the present disclosure.

FIG. 8 is a perspective view illustrating the second embodiment when it is assembled.

FIG. 9 is an exploded perspective view illustrating a third embodiment of the character concealable keycap module according to the present disclosure.

FIG. 10 is a cross-sectional view of the third embodiment.

FIG. 11 is an exploded perspective view illustrating a fourth embodiment of the character concealable keycap module according to the present disclosure.

FIG. 12 is a cross-sectional view illustrating the fourth embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

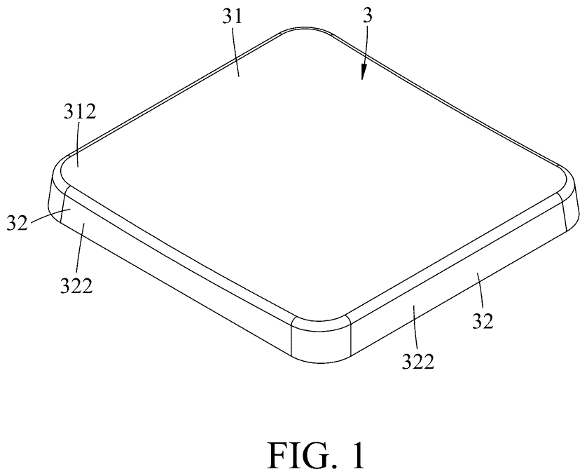

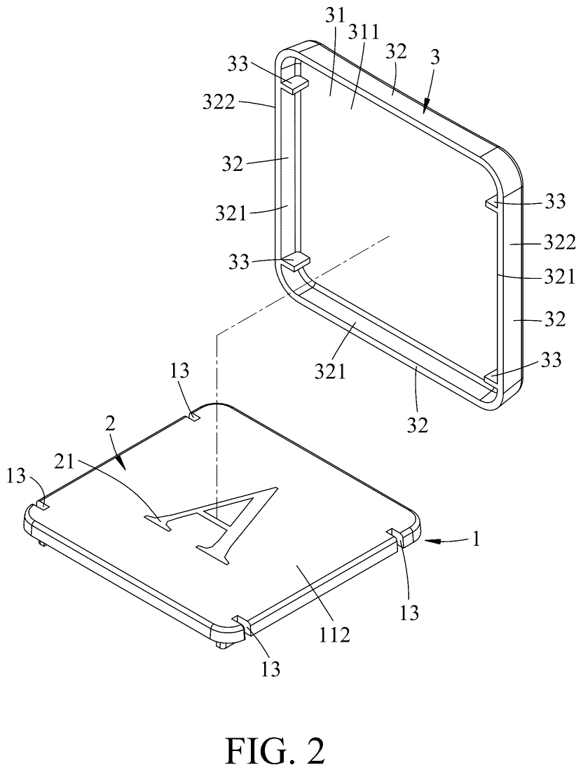

Referring to FIGS. 1 and 2, a first embodiment of a character concealable keycap module according to the present disclosure includes a first cap structure 1, a light covering layer 2, and a second cap structure 3. The character concealable keycap module is adapted to be mounted on a support module 61 of a key 6 that is in turn mounted on a backlight module 71 of a backlit keyboard 7.

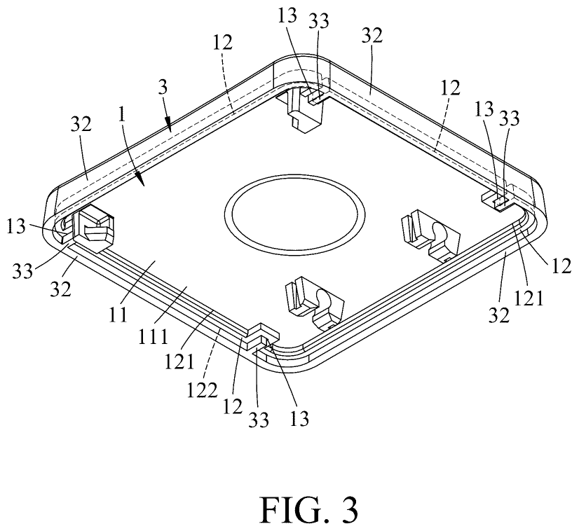

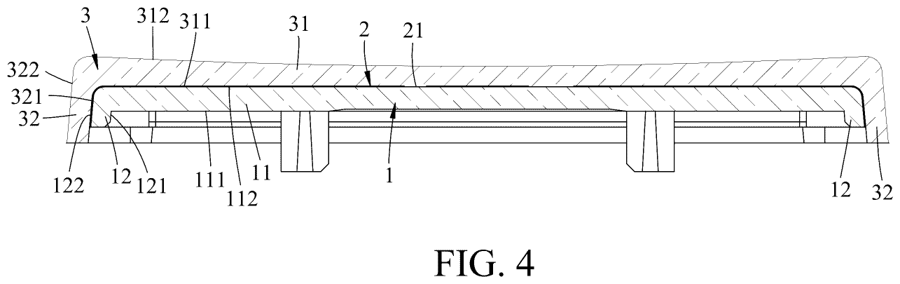

Referring to FIGS. 2 to 4, the first cap structure 1 is made of a transparent material and located above the backlight module 71. More specifically, the first cap structure 1 has a transmittance that is greater than 70%. The first cap structure 1 includes a first base wall 11, four first side walls 12 that each extend downward from the first base wall 11, and that are interconnected, and at least one groove 13 that is located on at least one of the first side walls 12.

The first base wall 11 has a bottom surface 111 that is connected to the first side walls 12, and an upper surface 112 that is opposite to the bottom surface 111.

Each of the first side walls 12 has an inner facing surface 121 that is connected to the bottom surface 111, and an outer facing surface 122 that is opposite to the inner facing surface 121, and that is connected to the upper surface 112.

In this embodiment, there are four grooves 13 formed into two pairs. The two pairs are respectively located on two of the first side walls 12. Each groove 13 indents inwardly from the outer facing surface 122 of the corresponding first side wall 12 and downwardly from the upper surface 112 of the corresponding first side wall 12.

In this embodiment, the light covering layer 2 is a spray painted layer on the first cap structure 1, and is black in color. The light covering layer 2 covers the first cap structure 1 and has a patterned hollow area 21 that defines a transparent character area on the first cap structure 1. The patterned hollow area 21 is proximate to the upper surface 112 of the first base wall 11. In this embodiment the character is an “A”.

The second cap structure 3 is similar to the light covering layer 2 in color. In this embodiment, the second cap structure 3 is also black, in other words, the second cap structure 3 and the light covering layer 2 are both black in color. The second cap structure 3 has a transmittance that is lower than that of the first cap structure 1, and is disposed above the first cap structure 1 to cover the light covering layer 2. In this embodiment the second cap structure 3 has a transmittance that ranges from 10% to 15%, and is located above the first cap structure 1 and the patterned hollow area 21 of the light covering layer 2. In other words, the transparent character area is located on the first base wall 11.

The second cap structure 3 includes a second base wall 31 that is located above the first base wall 11, four second side walls 32 that each extends downward from the second base wall 31, and that are interconnected, and at least one protruding portion 33 formed on at least one of the second side walls 32. In this embodiment, the second cap structure 3 has four protruding portions 33.

The second base wall 31 has a bottom surface 311 that is connected to the second side walls 32, and an upper surface 312 that is opposite to the bottom surface 311.

Each of the second side walls 32 has an inner facing surface 321 that is connected to the bottom surface 311 of the second base wall 31, and an outer facing surface 322 that is opposite to the inner facing surface 321 and that is connected to the upper surface 312 of the second base wall 31.

The four protruding portions 33 form two pairs, each pair is formed on one of the second side walls 32. Each pair of the protruding portions 33 protrude inwardly from the inner facing surface 321 of the corresponding second side wall 33. Each of the second side walls 32 covers a respective one of the first side walls 12. The four protruding portions 33 each correspond in position to one of the four grooves 13, and the four protruding portions 33 respectively extend into the four grooves 13. In this embodiment, the four protruding portions 33 are respectively press fitted to or fusion-bonded to the four grooves 13.

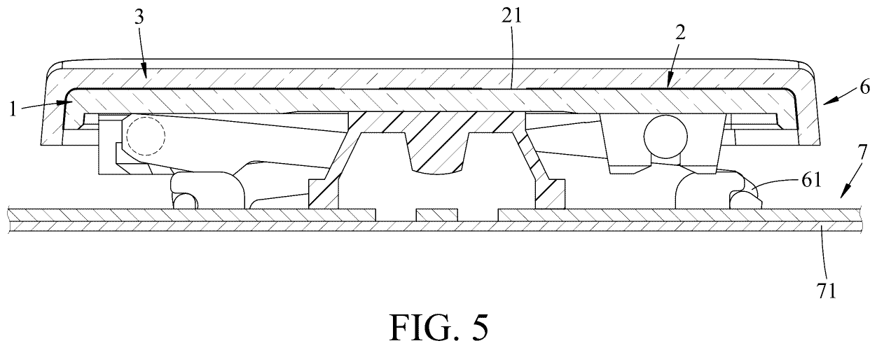

Referring to FIG. 5, the key 6 having the character concealable keycap module is mounted on and located above the backlight module 71 of the backlit keyboard 7. In this embodiment, the support module 61 may be a scissor switch structure; however, this is not a limitation of the disclosure. In other embodiments, the support module 61 may be another structure, for example, a butterfly structure.

Referring to FIGS. 1, 2, and 5, the transparent character area is located between the first cap structure 1 and the second cap structure 3, and since the second cap structure 3 has a transmittance lower than that of the first cap structure 1, and the light covering layer 2 has a similar color to the second cap structure 3, the transparent character area is not visible through the second cap structure 3 when the backlight module 71 is not switched on. In other words, in this embodiment, the user is unable to see the character “A” on the key 6.

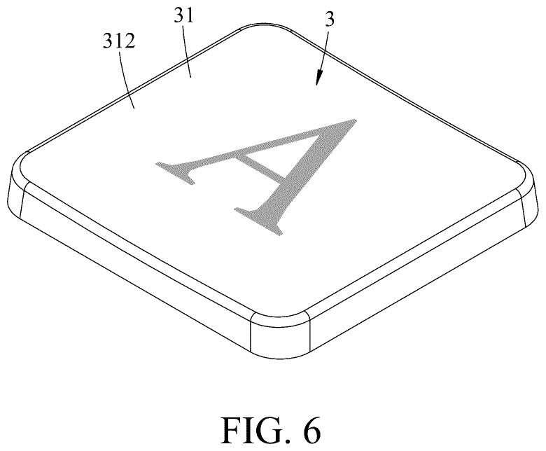

Referring to FIGS. 2, 5, and 6, when the backlight module 7 is switched on, light emitted from the backlight module 71 passes through the second cap structure 3, and the character “A” formed by the transparent character area is lit up and visible through the second cap structure 3 (note that in FIG. 6, the support module 61 and the backlight module 71 have been omitted). It should be noted that, in other embodiments and variations of the disclosure, the first cap structure 2 and the second cap structure 3 may be painted or coated in other colors, and the color, materials, and paint or coating of the light covering layer 2 is not limited in terms of color, material, and coating method.

The backlit keyboard 7 is mounted with a plurality of the character concealable keycap modules (only one is shown in the drawings) of the present disclosure, and may be assembled with a laptop computer. When the laptop computer is opened but the backlight module 71 of the backlit keyboard 7 is not emitting light, the backlit keyboard 7 is uniformly black and each of the characters defined by the transparent character areas of the first cap structures 1 are not visible. In other words, the character on each of the keys 6 is not visible when the backlight module 71 is not emitting light. This communicates a strong minimalist design aesthetic to the user. Only when the user presses a power button (of the laptop) which turns on the backlight module 71, will the keys 6 of the backlit keyboard 7 be lit up and the character on each of the keys 6 will be revealed. This dramatic presentation offers a unique visual and sensual experience to the user.

In this embodiment, the light covering layer 2 covers the first cap structure 1, and the second cap structure 3 is disposed above the first cap structure 1 to cover the light covering layer 2. Because the light covering layer 2 defining the transparent character area is covered and protected by the second cap structure 3 and because the second cap structure 3 is not coated with any coating layer for forming a character, frequent pressing and touching of the character concealable keycap module by the user will not degrade the light covering layer 2 with prolonged use, and the presentation of the character will not be effected. Therefore, the character concealable keycap module may have a long service life, and the visibility of the characters will not degrade over time.

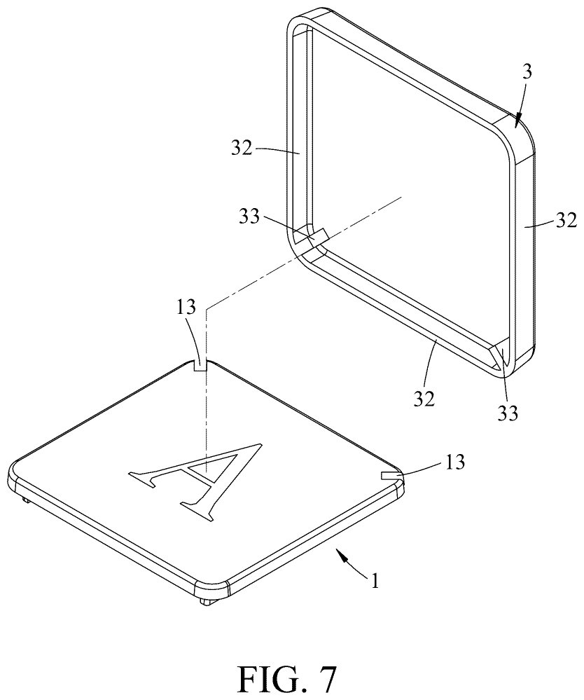

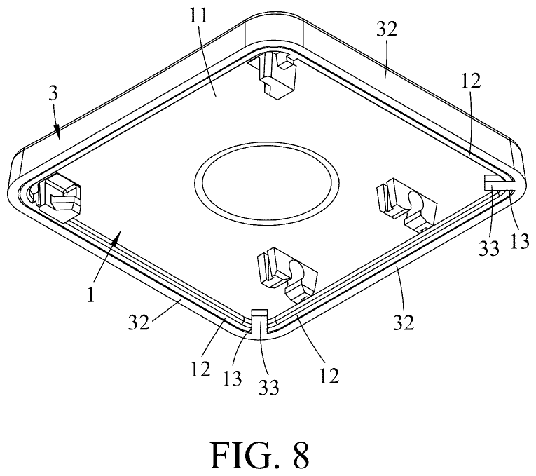

Referring to FIGS. 7 and 8, a second embodiment of the character concealable keycap module according to the present disclosure is similar to the first embodiment; however, the difference is that in the second embodiment, the first cap structure 1 includes two grooves 13 and the second cap structure 3 includes two protruding portions 33. Each of the two grooves 13 is located on joining ends of two of the first side walls 12. Each of the two protruding portions 33 is located on joining ends of two of the second side walls 32 and corresponds in position to one of the grooves 13.

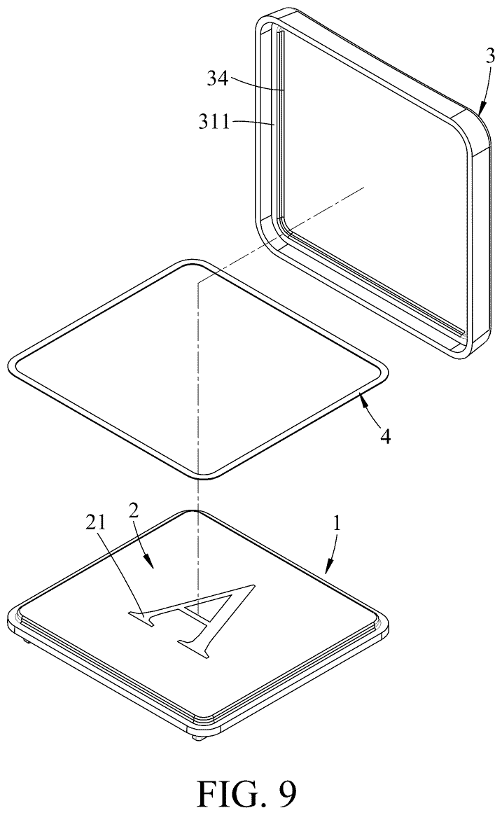

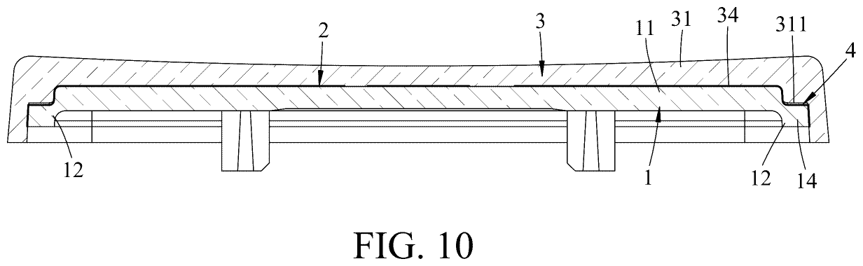

Referring to FIGS. 9 and 10, a third embodiment of the character concealable keycap module according to the present disclosure is similar to the first embodiment; however, in the third embodiment the groove 13 of the first cap structure 1 and the protruding portion 33 of the second cap structure 3 are omitted. Furthermore, the first cap structure 1 includes a protruding rim portion 14 that protrudes outwardly from and surrounds the outer facing surfaces 122 of the first side walls 12. The second cap structure 3 includes an underside groove 34 that indents upwardly from the bottom surface 311 of the second base wall 31, and that is located above the first base wall 11. In the third embodiment, the first base wall 11 is fitted into the underside groove 34, and the bottom surface 311 of the second base wall 31 is seated on a top face of the protruding rim portion 14. The character concealable keycap module further includes an adhesive layer 4 that surrounds the first base wall 11 and that is disposed between the bottom surface 311 of the second base wall 31 and the top face of the protruding rim portion 14 to provide a bonding therebetween.

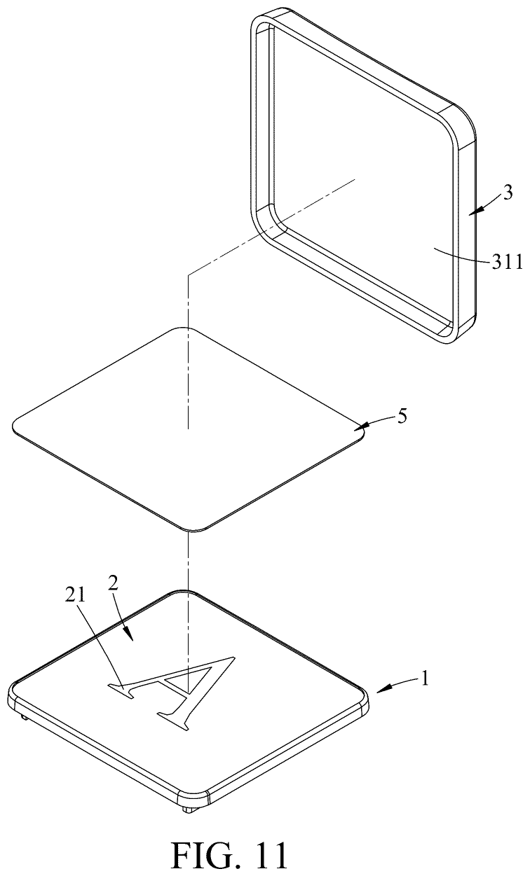

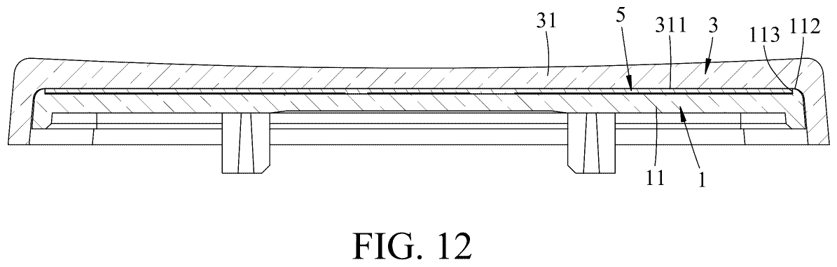

Referring to FIGS. 11 and 12, a fourth embodiment of the character concealable keycap module according to the present disclosure is similar to the first embodiment. However, in the fourth embodiment, the protruding portion 33 of the second cap structure 3, and the groove 13 of the first cap structure 1 are omitted. Instead, the first cap structure 1 includes a top groove portion 113 that is formed on the first base wall 11 below the second base wall 31. More specifically the top groove portion 113 is formed on the upper surface 112 of the first base wall 11, and the character concealable keycap module further includes an adhesive member 5. The adhesive member 5 is disposed in the top groove portion 113 and adheres the first base wall 11 to the second base 31. More specifically, the adhesive member 5 is disposed in the top groove portion 113 and is adhered to the bottom surface 311 of the second base wall 31.

In overview of the above, the second through fourth embodiments of the disclosure are different from the first embodiment in the way the first cap structure 1 and the second cap structure 3 are connected. Therefore the second to fourth embodiments may achieve the same functionality as the first embodiment.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A character concealable keycap module that is adapted to be mounted on a support module of a key that is in turn mounted on a backlight module of a backlit keyboard, said character concealed keycap module comprising:
a first cap structure made of a transparent material and located above the backlight module;
a light covering layer covering said first cap structure and having a patterned hollow area that defines a transparent character area on said first cap structure; and
a second cap structure that has a transmittance lower than that of said first cap structure, and that is disposed above said first cap structure to cover said light covering layer;
wherein when the backlight module is not switched on, said transparent character area is not visible through said second cap structure; and
wherein when the backlight module is switched on, light emitted from the backlight module passes through said second cap structure, and said transparent character area is visible through said second cap structure.

2. The character concealable keycap module as claimed in claim 1, wherein said second cap structure is similar to said light covering layer in color.

3. The character concealable keycap module as claimed in claim 1, wherein said second cap structure and said light covering layer are both black in color.

4. The character concealable keycap module as claimed in claim 1, wherein said light covering layer is located between said first cap structure and said second cap structure.

5. The character concealable keycap module as claimed in claim 1, wherein said light covering layer is a spray painted layer on said first cap structure.

6. The character concealable keycap module as claimed in claim 1, wherein said second cap structure has a transmittance that ranges from 10% to 15%.

7. The character concealable keycap module as claimed in claim 1, wherein said first cap structure has a transmittance that is greater than 70%.

8. The character concealable keycap module as claimed in claim 1, wherein:
said first cap structure includes a first base wall, four first side walls that each extend downward from said first base wall and that are interconnected, and at least one groove that is located on at least one of said first side walls;
said transparent character area is located on said first base wall;
said second cap structure includes a second base wall that is located above said first base wall, four second side walls that each extend downward from said second base wall and that are interconnected, and at least one protruding portion formed on at least one of said second side walls;
each of said second side walls covers a respective one of said first side walls, said at least one protruding portion extending into said at least one groove.

9. The character concealable keycap module as claimed in claim 8, wherein:
said at least one groove indents downwardly from an upper surface of said first base wall and inwardly from an outer facing surface of said at least one of said first base wall; and
said at least one protruding portion protrudes inwardly from an inner facing surface of said at least one of said second side walls.

10. The character concealable keycap module as claimed in claim 1, wherein:
said first cap structure includes a first base wall, four first side walls that extend downwards from said first base wall, and that are interconnected, and a protruding rim portion that protrudes outwardly from and surrounds outer facing surfaces of said first side walls;
said transparent character area is located on said first base wall;
said second cap structure includes a second base wall that is located above said first base wall, four second side walls that extend downwards from said first base wall, and that are interconnected, an underside groove that is indented upwardly from a bottom surface of said second base wall, and that is located above said first base wall;
said first base wall is fitted into said underside groove, said bottom surface of said second base wall being seated on a top face of said protruding rim portion; and
said character concealable keycap module further comprising an adhesive layer that surrounds said first base wall and that is disposed between said top face of said protruding rim portion and said bottom surface of said second base wall to provide a bonding therebetween.

11. The character concealable keycap module as claimed in claim 1, wherein:
said first cap structure includes a first base wall, four first side walls that each extend downwards from said first base wall, and that are interconnected, and a top groove portion that is formed on said first base wall below said second base wall;
said transparent character area is located on said first base wall;
said second cap structure includes a second base wall that is located above said first base wall, and four second side walls that each extend downwards from said first base wall, and that are interconnected;
said second side walls are respectively located on outer facing surfaces of said first side walls;
said character concealable keycap module further comprising an adhesive member that is disposed in said top groove portion and that adheres said first base wall to said second base wall.
